(19) United States
(12) Patent Application Publication
(10) Pub. No.: US 2024/0213637 A1
(43) Pub. Date: Jun. 27, 2024

(54) BATTERY-FIXING BONDING TAPE AND MOBILE TERMINAL

(71) Applicant: Dongguan Amperex Technology Limited, Dongguan (CN)

(72) Inventors: Taosheng WANG, Dongguan (CN); Xuecheng LI, Dongguan (CN)

(73) Assignee: Dongguan Amperex Technology Limited, Dongguan, GD (CN)

(21) Appl. No.: 18/392,779

(22) Filed: Dec. 21, 2023

(30) Foreign Application Priority Data
Dec. 21, 2022 (CN) 202211653010.6

(51) Int. Cl. H01M 50/595; H01M 50/586; H04M 1/02

(52) U.S. Cl. CPC H01M 50/595; H01M 50/586; H04M 1/0262; H01M 2220/30

(57) ABSTRACT

A bonding tape for a battery includes a first adhesive layer, a second adhesive layer, a substrate layer, and an original film. The first adhesive layer and the second adhesive layer are located on two sides of the substrate layer respectively. The first adhesive layer is bonded to a battery. The second adhesive layer includes a first region and a second region. The original film is disposed in the first region. The second region is bonded to a battery compartment. A through-hole is created on the original film. The bonding tape of this application reduces an overall thickness of adhesive tape, improves the energy density of the battery, and at the same time, improves the anti-drop performance of the battery and increases a drop window pass rate.

### CROSS-REFERENCE TO THE RELATED APPLICATION

This application claims the benefit of priority of Chinese Patent Application No. 202211653010.6, filed on Dec. 21, 2022, the contents of which are incorporated herein by reference in their entirety.

### TECHNICAL FIELD

This application relates to the technical field of electronic devices, and in particular, to a battery-fixing bonding tape and a mobile terminal.

### BACKGROUND

During repair of mobile terminals such as a mobile phone and a tablet computer, a battery needs to be detached from a battery compartment of the mobile terminal. However, the battery is mostly bonded to the battery compartment by a wrapping film together with double-sided tape. The wrapping film is actually single-sided tape with a thickness of approximately 40 μm to 70 μm. The double-sided tape is affixed to an adhesive-free side of the wrapping film. The overall thickness of the tape is approximately 140 μm to 170 μm, thereby impairing the energy density. Moreover, during disassembling of the battery, the double-sided tape in the prior art needs to be detached by means of a screwdriver, a utility knife, or other sharp tools, and the battery is prone to scratching or even breakage and electrolyte leakage. In severe circumstances, the main body of a battery cell is damaged and thereby results in safety problems such as contact between a cathode and an anode, an internal short circuit, and fire.

### SUMMARY

This application provides a battery-fixing bonding tape and a mobile terminal. The appropriate bonding tape disposed between a battery and a battery compartment facilitates non-destructive disassembly of the battery. In addition, the bonding tape includes a first region and a second region. The coordination between the first region and the second region makes it convenient to properly fix the battery in the battery compartment (fixture), thereby improving the anti-drop performance of the battery.

According to a first aspect, this application provides a battery-fixing bonding tape. The bonding tape includes a first adhesive layer, a second adhesive layer, a substrate layer, and an original film. The first adhesive layer and the second adhesive layer are located on two sides of the substrate layer respectively. The first adhesive layer is configured to be bonded to a battery. The second adhesive layer includes a first region and a second region. The original film is disposed in the first region on a surface away from the substrate layer. The second region is configured to be bonded to a battery compartment.

In some embodiments, along the first direction, the first direction is a thickness direction of the bonding tape, a projected area of the original film is A, and a projected area of the second adhesive layer is B, satisfying: 0.1≤ A/B≤ 0.7. Preferably, 0.2≤A/B≤0.5.

In some embodiments, along the first direction, the projected area of the original film is less than the projected area of the second adhesive layer.

In some embodiments, a shape of the second region includes one or more of a rectangle, a square, a triangle, a circle, or another regular or irregular shape. Specifically, the shape of the second region may be a rectangle, a square, a triangle, a circle, or another regular or irregular shape alone, or, may be a combination of at least two thereof, for example, a combination of a rectangle and a square, a combination of a triangle and a circle, and so forth.

In some embodiments, the original film contains a through-hole. At least a part of the second adhesive layer covered by the original film in the first region of the second adhesive layer is bonded to the battery compartment through the through-hole.

In some embodiments, the first adhesive layer contains a granular adhesive. An area of the granular adhesive constitutes 30% to 70% of an area of a side of the first adhesive layer, and the side is away from the substrate layer.

In some embodiments, a ratio of a thickness of the second adhesive layer to a thickness of the first adhesive layer is M, satisfying: 1.5≤ M≤2.

The thickness direction of the first adhesive layer is perpendicular to a surface of a battery cell, and the thickness direction of the second adhesive layer is parallel to the thickness direction of the first adhesive layer.

In some embodiments, the bonding tape satisfies: (A) a thickness of the first adhesive layer is 5 μm to 40 μm: (B) a thickness of the second adhesive layer is 10 μm to 50 μm.

In some embodiments, the bonding tape satisfies at least one of the following conditions: (A) the thickness of the first adhesive layer is 5 μm to 15 μm: and (B) the thickness of the second adhesive layer is 10 μm to 25 μm.

In some embodiments, a second direction is a width direction of the bonding tape, a length direction of the bonding tape is consistent with an extension direction of a tab of the battery, and the width direction of the bonding tape is perpendicular to the length direction of the bonding tape. Along the second direction, the second region is disposed on both sides of the first region.

According to a second aspect, this application provides a mobile terminal, including a battery compartment, a battery, and the bonding tape described above. The battery is fixed in the battery compartment by the bonding tape.

In some embodiments, a bonding force between the first adhesive layer and the battery is a first bonding force F₁, and a bonding force between the second adhesive layer and the battery compartment is a second bonding force F₂, satisfying: F₁<F₂.

In some embodiments, a bonding force between the first adhesive layer and the battery is a first bonding force F₁, and a bonding force between the second adhesive layer and the battery compartment is a second bonding force F₂, satisfying: F₂−F₁≥700 g/in.

In some embodiments, a lifting portion is disposed between the first adhesive layer and the battery. The lifting portion includes a first part and a second part. The first part is disposed opposite to the second part. The first part contains a bonding layer. The bonding layer is bonded to the battery. The second part extends to a side of the battery, and the side is away from the first adhesive layer. Specifically, the bonding layer is bonded to the battery. A side of the first part, which is away from the bonding layer, is bonded to the first adhesive layer, and is staggered from the position of granular adhesive on the first adhesive layer, so as to reduce an acting force generated during disassembly of the battery and facilitate the disassembly. It is hereby noted that a bonding position between the first part of the lifting portion and the battery may be not staggered from the position of the granular adhesive on the first adhesive layer. In this case, a relatively large acting force needs to be exerted during disassembly of the battery. The second part of the lifting portion extends to a side of the battery and is folded, the side being away from the first adhesive layer. After being folded, the second part may snugly fit the side of the battery or not, depending on the actual situation, without being unduly limited in this application. During disassembly of the battery, the second part of the lifting portion is lifted so that the first part exerts a tensile force on the battery, and the tensile force is transmitted away from battery compartment, so as to detach the battery from the battery compartment.

In some embodiments, an area of the battery is denoted by S₁, and an area of the second region is denoted by S₂, satisfying: 0.3≤S₂/S₁≤0.9.

The area S₁ of the battery is the area of a side of the battery, the side being oriented toward the bonding tape. The side of the battery, which is oriented toward the bonding tape, is bonded to the first adhesive layer of the bonding tape. The second region of the second adhesive layer is bonded to the battery compartment. In some embodiments, an area of the battery is denoted by S₁, and an area of the second region is denoted by S₂, satisfying: 0.5≤ S₂/S₁≤0.8.

In some embodiments, along the third direction, the mobile terminal satisfies at least one of the following conditions:
1) a distance from a head end of the second region to a head end of the substrate layer is 0.5 mm to 5 mm;
2) a distance from an ending end of the second region to an ending end of the substrate layer is 0.5 mm to 5 mm;
3) a distance from the head end of the substrate layer to a head end of a battery cell in the battery is 0.2 mm to 5 mm;
4) a distance from the ending end of the substrate layer to an ending end of the battery cell in the battery is 0.2 mm to 5 mm.

The third direction is a protruding direction of the tab of the battery, and the third direction is perpendicular to the first direction.

In some embodiments, along the third direction,
1) the distance from the head end of the second region to the head end of the substrate layer is 3 mm to 5 mm;
2) the distance from the ending end of the second region to the ending end of the substrate layer is 3 mm to 5 mm;
3) the distance from the head end of the substrate layer to the head end of the battery cell in the battery is 0.5 mm to 3 mm;
4) the distance from the ending end of the substrate layer to the ending end of the battery cell in the battery is 0.5 mm to 3 mm.

Along the third direction, an end of the substrate layer, which is close to the tab of the battery, is the head end of the substrate layer; and an end of the substrate layer, which is away from the tab of the battery, is the ending end of the substrate layer.

Using the head end of the substrate layer as a reference, the end that is close (closest) to the head end of the substrate layer is the head end of the second region. Similarly, using the ending end of the substrate layer as a reference, the end that is close (closest) to the ending end of the substrate layer is the ending end of the second region.

The end of the battery cell, which is close to the tab, is the head end of the battery cell. The end of the battery cell, which is away from the tab, is the ending end of the battery cell. The head end of the substrate layer is in the same direction as the head end of the battery cell. The ending end of the substrate layer is in the same direction as the ending end of the battery cell.

The technical solutions provided in some embodiments of this application bring at least the following beneficial effects:
(1) In this application, the first region of the second adhesive layer is covered with an original film. The original film is intended to avoid adhesion of the second adhesive layer to the components (such as a ribbon cable) in the battery compartment, and in turn, avoid breakage of the components in case of dropping. In addition, a through-hole may be created on the original film, making it convenient to adjust the difference between the first bonding force F₁ and the second bonding force F₂ on the two sides of the substrate layer to fall within an appropriate range, and in turn, improving the anti-drop performance of the battery;
(2) By controlling the thickness of the first adhesive layer, the thickness of the second adhesive layer, and the thickness ratio between the two adhesive layers to fall within an appropriate range, this application implements proper adhesion between the battery and the battery compartment on the one hand, and the battery can be disassembled non-destructively on the other hand, and the anti-drop performance of the battery is further improved;
(3) Compared with the adhesive layer in the prior art, the bonding tape of this application possesses a reduced thickness, and improves the energy density (ED) of the battery, that is, improves the energy density of the battery and the anti-drop performance concurrently: and
(4) By disposing a lifting portion between the first adhesive layer and the battery, this application exerts an acting force on the battery, and the acting force is transmitted away from the bonding tape, thereby making it convenient to remove the battery from the battery compartment.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below are merely a part of embodiments of this application. A person skilled in the art may derive other drawings from such drawings without making any creative effort.

FIG. 1 is a schematic structural diagram of a bonding tape in a battery compartment according to an embodiment of this application:

FIG. 2 is a side view of a bonding tape and a battery in a battery compartment according to an embodiment of this application:

FIG. 3 is a schematic structural diagram of a second region formed according to an embodiment of this application:

FIG. 4 is a schematic close-up view of a partial structure of a battery cell according to an embodiment of this application:

FIG. 5 is a schematic structural diagram of three types of second regions formed according to an embodiment of this application:

FIG. 6 is a partial cross-sectional view of a battery cell according to an embodiment of this application:

FIG. 7 is a schematic structural diagram of a battery cell according to an embodiment of this application:

FIG. 8 shows a picture of damaged corners of a battery cell according to in this application: and

FIG. 9 shows a picture of deformed head and ending of a battery cell according to this application.

### DETAILED DESCRIPTION

To make the objectives, technical solutions, and advantages of this application clearer, the following describes this application in further detail with reference to drawings and embodiments. Understandably, the specific embodiments described herein are merely intended to explain this application, but are not intended to limit this application.

Currently, in order to facilitate secondary utilization of a battery, bonding tapes are usually applied, including ordinary double-sided tape, easy-to-pull tape, or a combination wrapping film and dinary double-sided tape, or the like. For example, in the related art, the battery is fixed and bonded to the battery compartment by using a combination of a wrapping film and ordinary double-sided tape, and the battery is disassembled by additional means of a ring-pull. The wrapping film is a type of single-sided tape formed of a substrate and an adhesive layer. The adhesive layer is de-adhered by ink to obtain granular adhesive tape (a part of the adhesive layer is adhesive, and a part of the adhesive layer is covered by ink). Ordinary double-sided tape is affixed onto an adhesive-free side of the wrapping film. The ordinary double-sided tape consists of a substrate layer and two adhesive layers. The thickness of a wrapping film commonly available in the market is approximately 40 μm to 70 μm, and the thickness of the ordinary double-sided tape is approximately 100 μm. The aggregate thickness of the wrapping film and the double-sided tape is 140 μm to 170 μm, thereby impairing the energy density of the battery. In addition, the shape, distribution, and area of the adhesive side of the bonding tape make an impact on the anti-drop performance. Therefore, different types of batteries impose different design requirements on the wrapping film. If a special-purpose gravure roller is made for the wrapping film of each type of battery for gravure coating, then additional cost of the gravure roller is caused on the one hand, and on the other hand, the gravure roller needs to be replaced frequently once the battery is replaced, thereby increasing human resource cost and time cost. In addition, it is difficult to non-destructively disassemble the battery bonded by ordinary double-sided tape. In the related art, the battery may be bonded to the battery compartment by easy-to-pull tape, but the easy-to-pull tape is expensive.

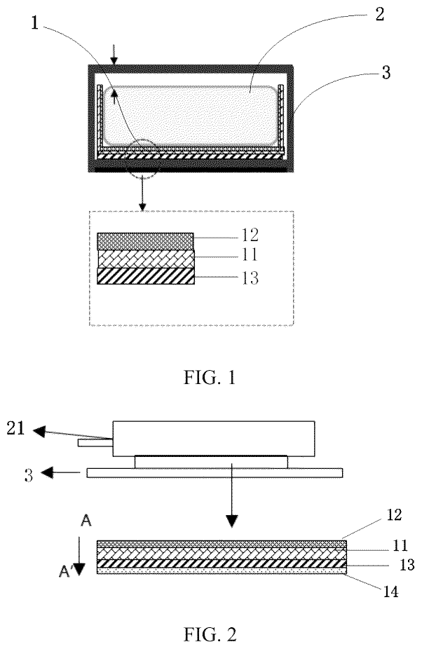

To solve the above technical problems, this application discloses a technical solution that compounds the wrapping film and the double-sided tape into a whole to reduce the overall thickness of the battery. In this way, the original 5-layer structure consisting of the two-layer PET wrapping film (substrate layer+adhesive layer) and the three-layer ordinary double-sided tape (substrate layer+two adhesive layers) is reduced to a 3-layer structure consisting of a PET substrate layer plus a first adhesive layer and a second adhesive layer, as shown in FIG. 1. The thickness is reduced by approximately 50 μm, and the energy density of the battery is increased by approximately 1% at a low cost.

Referring to FIG. 1 and FIG. 2, the bonding tape 1 includes a substrate layer 11 and a first adhesive layer 12 and a second adhesive layer 13 that are located on two sides of the substrate layer 11 respectively. The first adhesive layer 12 is configured to be bonded to the battery 2 in the mobile terminal, and the second adhesive layer 13 is configured to be bonded to the battery compartment 3 in the mobile terminal. The second adhesive layer 13 includes a first region and a second region 131. The second region 131 is configured to be bonded to the battery compartment 3 in the mobile terminal to fix the battery 2 in the battery compartment 3. The bonding tape further includes an original film 14. The original film 14 is disposed in the first region. In a case that a PCB ribbon cable of the battery and a second adhesive side are coplanar, the original film 14 is disposed in the first region to avoid the bonding of the second adhesive layer 13 to the PCB ribbon cable of the battery. A through-hole (not shown in the drawing) may be created on the original film 14. The second adhesive layer may be bonded to the battery compartment 3 through the through-hole. The through-hole is configured to further increase the bonding force between the second adhesive layer 13 and the battery compartment 3 and adjust the difference between the second bonding force F₂ and the first bonding force F₁ to fall within an appropriate range.

The shapes of the through-hole include at least one of a round hole, a square hole, a triangular hole, a polygonal hole, and another regular or irregular shape. The number of through-holes is plural. The plurality of through-holes are arranged in arrayed or non-arrayed form depending on the actual situation. The arrangement of the through-holes is not particularly limited in this application. The location of the through-holes needs to preferably avoid the location of the PCB ribbon cable of the battery in order to prevent the bonding of the PCB ribbon cable of the battery to the second adhesive layer.

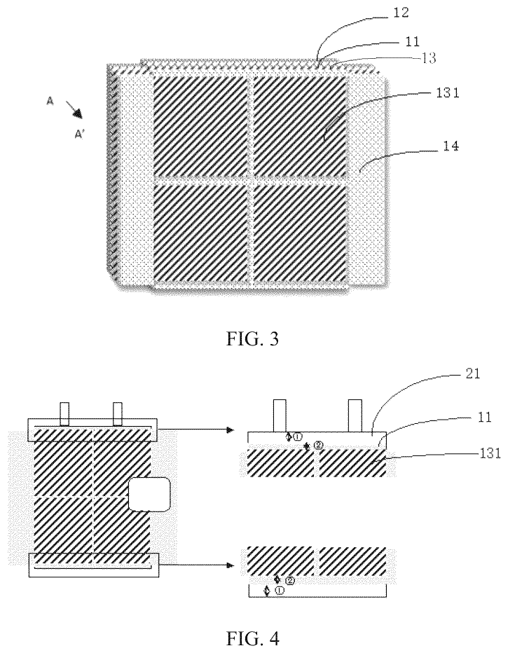

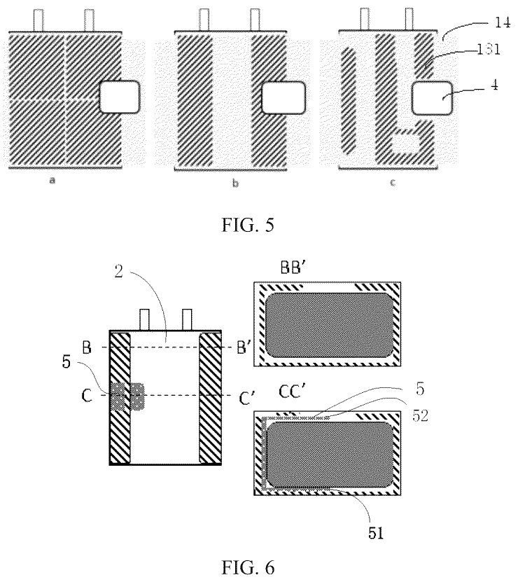

Referring to FIG. 3, the second adhesive layer 13 includes a second region 131. A region not covered by the original film 14 on the second adhesive layer 13 is the second region 131. A region covered by the original film 14 on the second adhesive layer is the first region. The second region 131 is configured to be bonded to the battery compartment 3. By disposing the second region 131 and creating the through-hole on the original film 14, this application properly fixes the battery 2 inside the battery compartment 3, and prevents the battery from being damaged inside the battery compartment after dropping, thereby improving the anti-drop performance of the battery while improving the energy density (ED) of the battery, and achieving a higher drop window pass rate. The shapes of the second region 131 include one or more of a rectangle, a square, a triangle, a circle, or another regular or irregular shape, or a combination thereof. The shapes and distribution of the second region 131 may be designed as shown in FIG. 5. It is hereby noted that FIG. 5 only shows an exemplary distribution of the second region 131. All distribution circumstances conceivable by a person of ordinary skill in the art are fall within the scope of this application. The shapes and distribution are not limited in this application.

In some embodiments of this application, along the first direction, a projected area of the original film 14 is A, and a projected area of the second adhesive layer 13 is B, satisfying: 0.1≤A/B≤0.7. With the increase of the projected area of the original film 14, the adhesive force of the bonding tape to the battery compartment 3 decreases. When A/B is greater than 0.7, the bonding force of the bonding tape to the battery compartment 3 is deficient, and the battery 2 is prone to be wobbling and damaged in a dropping process. When A/B is less than 0.1, the area of the original film 14 is deficient, thereby impairing the effect of preventing the second adhesive layer from being bonded to the components (such as the ribbon cable) in the battery compartment 3 of the battery 2, making the second adhesive layer prone to be bonded to the components in the battery compartment 3, and making the components prone to be damaged in a case of dropping. When 0.1≤A/B≤0.7, the probability of bonding of the second adhesive layer 13 to the components in the battery compartment is reduced, and the probability of damaging the battery 2 is reduced in a case of dropping.

As an example, the ratio A/B of the projected area A of the original film 14 to the projected area B of the second adhesive layer 13 is 0.1, 0.2, 0.25, 0.35, 0.4, 0.5, 0.6, 0.7, or a value falling within a range formed by any two thereof.

In some embodiments of this application, when 0.2≤A/B≤0.5, the second bonding force may be further adjusted by adjusting the area of the original film 14. In this way, the difference between the first bonding force F₁ and the second bonding force F₂ is in an appropriate range, and the battery can be detached more non-destructively.

As an example, the ratio A/B of the projected area A of the original film 14 to the projected area B of the second adhesive layer 13 is 0.2, 0.3, 0.35, 0.4, 0.45, 0.5, or a value falling within a range formed by any two thereof.

In some embodiments of this application, the first bonding force F₁ between the first adhesive layer 12 and the battery 2 is less than the second bonding force F₂ between the second adhesive layer 12 and the battery compartment 3, and satisfies: F₁<F₂. When removing the battery, in order to enable the battery to be detached from the first adhesive layer 12 non-destructively, the second bonding force F₂ between the second adhesive layer 12 and the battery compartment 3 needs to be greater than the first bonding force F₁ between the first adhesive layer 12 and the battery 2, so as to ensure that the battery 2 can be detached from the interface between the adhesive tape and the battery cell and pulled out of the battery compartment 3. In addition, by controlling the first bonding force F₁ to be less than the second bonding force F₂, an excessive shearing force between the first adhesive layer 12 and the battery 2, which is caused by the first bonding force F₁ greater than or equal to the second bonding force F₂, can be avoided in the dropping process of the battery. The large shearing force in the dropping process of the battery is prone to damage the surface of the battery, and the damage results in a risk of leaking the electrolyte solution.

In some embodiments of this application, the first bonding force F₁ between the first adhesive layer 12 and the battery and the second bonding force F₂ between the second adhesive layer 13 and the battery compartment satisfies: F₂−F₁≥700 g/in. In this case, the battery is detached more non-destructively, and the battery is not prone to be damaged during dropping. Generally, the second bonding force F₂ is preferably set to a larger value. However, for convenience of cleaning the adhesive tape out of the battery compartment later, the second bonding force satisfies: F₂≤3500 g/in.

In some embodiments of this application, an area of the battery 2 is denoted by S₁, and an area of the second region 131 is denoted by S₂, satisfying: 0.3≤S₂/S₁≤0.9. In this case, the effect of bonding between the second region 131 and the battery compartment 3 is good enough to avoid wobbling of the battery 2 inside the battery compartment 3 during use, and fix the battery 2 inside the battery compartment 3 firmly. In addition, by controlling the difference between the first bonding force F₁ and the second bonding force F₂ and controlling the effective bonding area of the second region 131, the bonding between the battery 2 and the battery compartment 3 is caused to be firm. When bonded firmly, the second region 131 and the battery compartment 3 may be regarded as a whole, thereby further improving the anti-drop performance.

As an example, the ratio S₂/S₁ of the area S₂ of the second region 131 to the area S₁ of the battery 2 is 0.3, 0.4, 0.5, 0.6, 0.7, 0.8, 0.9, or a value falling within a range formed by any two thereof.

In some embodiments of this application, the area of the battery 2 is denoted by S₁, and the area of the second region 131 is denoted by S₂, satisfying: 0.5≤S₂/S₁≤ 0.8. In this case, the effect of fixing the battery 2 in the battery compartment 3 is further improved.

As an example, the ratio S₂/S₁ of the area S₂ of the second region 131 to the area S₁ of the battery 2 is 0.5, 0.6, 0.7, 0.8, or a value falling within a range formed by any two thereof.

Referring to FIG. 4 (the left side of FIG. 4 is the original drawing, and the right side is a close-up view), along the protruding direction of the tab of the battery, the distance from the head end of the second region 131 to the head end of the substrate layer 11 is denoted by a₁, and a₁ is 0.5 to 5 mm (the length indicated by \textcircled{2} in FIG. 4): the distance from the ending end of the second region 131 to the ending end of the substrate layer 11 is denoted by a₂, and a₂ is 0.5 to 5 mm (the length indicated by \textcircled{2} in FIG. 4); the distance from the head end of the substrate layer 11 to the head end of the battery cell 21 in the battery is denoted by b₁, and b₁ is 0.2 to 5 mm (the length indicated by \textcircled{1} FIG. 4); and, the distance from the ending end of the substrate layer 11 to the ending end of the battery cell 21 in the battery is denoted by b₂, and b₂ is 0.2 to 5 mm (the length indicated by \textcircled{1} in FIG. 4). The distance b from the head/ending end of the substrate layer 11 to the head/ending end of the battery cell 21 in the battery is determined for allowing for fluctuation of a tolerance of the bonding tape 1, and is intended to prevent the bonding tape 1 from exceeding the head/ending of the battery 2. a₁ and a₂ are determined with reference to the result of the drop test. For example, when a₁ and a₂ are 0 mm, 3 mm, and 5 mm, as learned in relevant tests, the damage ratio of the surface of the battery is 5/10, 1/10, and 0/10, respectively, and the deformation ratio at the head and ending of the battery is 0/10. When a₁ and a₂ are greater than 5 mm, for example, are 10 mm, the damage ratio of the surface of the battery is 0/10, but the deformation ratio of the head and ending of the battery is 4/10. Therefore, in selecting the range of the distances a₁ and a₂, it is necessary to balance and comprehensively consider the damage ratio of the surface of the battery and the deformation ratio of the head and ending of the battery. It is hereby noted that the value of a₁ and the value of a₂ may be the same or different.

As an example, the distance a₁ from the head end of the second region 131 to the head end of the substrate layer 11 is 0.5 mm, 1 mm, 2 mm, 3 mm, 4 mm, 5 mm, or a value falling within a range formed by any two thereof.

The distance a₂ from the ending end of the second region 131 to the ending end of the substrate layer 11 is 0.5 mm, 1 mm, 2 mm, 3 mm, 4 mm, 5 mm, or a value falling within a range formed by any two thereof.

As an example, the distance b₁ from the heading end of the substrate layer 11 to the head end of the battery cell 21 in the battery is 0.2 mm, 1 mm, 2 mm, 3 mm, 4 mm, 5 mm, or a value falling within a range formed by any two thereof. The distance b₂ from the ending end of the substrate layer 11 to the ending end of the battery cell 21 in the battery is 0.2 mm, 1 mm, 2 mm, 3 mm, 4 mm, 5 mm, or a value falling within a range formed by any two thereof.

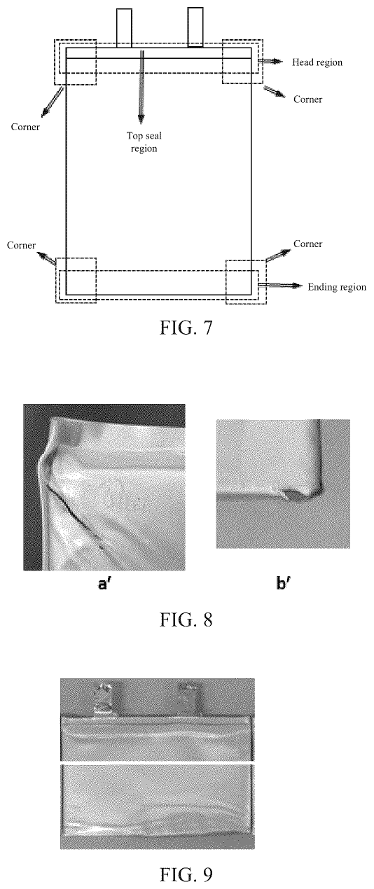

With reference to FIG. 7, the third direction, that is, the protruding direction of the tab of the battery, is a direction from the ending region of the battery cell 21 to the head region of the battery cell 21. The tab of the battery extends from the head region of the battery cell 21. The head region of the battery cell 21 is oriented toward the top of the battery 2, and the ending region of the battery cell 21 is oriented toward the bottom of the battery 2.

In some embodiments of this application, along the third direction, the distance from the head end of the second region 131 to the head end of the substrate layer 11 is denoted by a₁, and a₁ is 3 to 5 mm; the distance from the ending end of the second region 131 to the ending end of the substrate layer 11 is denoted by a₂, and a₂ is 3 to 5 mm; the distance from the head end of the substrate layer 11 to the head end of the battery cell 21 in the battery is denoted by b₁, and b₁ is 0.5 to 3 mm; and, the distance from the ending end of the substrate layer 11 to the ending end of the battery cell 21 in the battery is denoted by b₂ and is 0.5 to 3 mm. On the one hand, such settings are intended to ensure that the area of the bonding tape is large enough to provide effective fixation. On the other hand, considering the stress distribution on the battery surface caused by the adhesion of the bonding tape to the battery, the smaller the distance from the second region 131 to the edge of the head/ending end of the battery cell 21, the greater the stress on the corresponding position, and the more prone the corresponding position is to be damaged by fatigue. Therefore, preferably, a₁ and a₂ fall within the range of 3 to 5 mm, and b₁ and b₂ fall within the range of 0.5 to 3 mm.

As an example, the distance a₁ from the heading end of the second region 131 to the head end of the substrate layer 11 is 3 mm, 3.5 mm, 4 mm, 4.5 mm, 5 mm, or a value falling within a range formed by any two thereof. The distance a₂ from the ending end of the second region 131 to the ending end of the substrate layer 11 is 3 mm, 3.5 mm, 4 mm, 4.5 mm, 5 mm, or a value falling within a range formed by any two thereof.

As an example, the distance b₁ from the heading end of the substrate layer 11 to the head end of the battery cell 21 in the battery is 0.5 mm, 1 mm, 1.5 mm, 2 mm, 2.5 mm, 3 mm, or a value falling within a range formed by any two thereof. The distance b₂ from the ending end of the substrate layer 11 to the ending end of the battery cell 21 in the battery is 0.5 mm, 1 mm, 1.5 mm, 2 mm, 2.5 mm, 3 mm, or a value falling within a range formed by any two thereof.

In some embodiments of this application, at least a part of the first adhesive layer 12 contains a granular adhesive. An area of the granular adhesive constitutes 30% to 70% of an area of a side of the first adhesive layer 12, and the side is oriented toward the battery 2. The granular adhesive is formed by de-adhering the first adhesive layer 12 with ink. At least a part of the first adhesive layer 12 is covered with ink to form an ink overlayer. The ink overlayer possesses no bonding properties. The adhesive side on which no ink overlayer is formed on the first adhesive layer 12 is a granular adhesive side. The granular adhesive side includes granular adhesive. The granular adhesive side possesses bonding properties. The granular adhesive side weakens the bonding properties of the first adhesive layer 12 to facilitate disassembly of the battery. The formed granular adhesive is usually distributed in a matrix of dots with a diameter of 0.5 to 5 mm and spacing of 0.5 to 20 mm.

Referring to FIG. 5, an avoidance hole 4 is created in the bonding tape 1. The avoidance hole 4 runs through the bonding tape to accommodate a lifting portion 5. The lifting portion 5 is configured to facilitate the removal of the battery 2 from the battery compartment 3. The lifting portion 5 includes a ring-pull. Specifically, the lifting portion 5 is disposed between the first adhesive layer 12 and the battery 2. The lifting portion 5 is disposed around two opposite sides of the battery 2. The lifting portion 5 includes a first part 51 and a second part 52 disposed opposite to the first part 51. The first part 51 is bonded to a battery side on which the first adhesive layer 12 is bonded, and is positionally staggered from the granular adhesive on the first adhesive layer 12. The second part 52 extends to the battery side away from the first adhesive layer 12. During disassembly of the battery 2, the second part 52 of the lifting portion 5 is lifted so that the lifting portion 5 exerts an acting force on the battery 2, and the acting force is transmitted away from bonding tape 1, so as to detach the battery 2 from the battery compartment 3.

In some embodiments of this application, a ratio of a thickness of the second adhesive layer 13 to a thickness of the first adhesive layer 12 is M, satisfying: 1.5≤ M≤2. By controlling the thickness ratio between the first adhesive layer 12 and the second adhesive layer 13, the bonding and fixing effect of the bonding tape 1 is improved, and a high energy density of the battery is maintained at the same time.

As an example, the ratio M of the thickness of the second adhesive layer 13 to the thickness of the first adhesive layer 12 is 1.5, 1.6, 1.7, 1.8, 1.9, 2, or a value falling within a range formed by any two thereof.

Further, the bonding tape satisfies: (A) the thickness of the first adhesive layer 12 is 5 μm to 40 μm: (B) the thickness of the second adhesive layer 13 is 10 μm to 50 μm. On the one hand, the thickness of the adhesive layer impairs the effect of the bonding force, Within a specified range of thickness, the thicker the adhesive layer, the more sites at which the adhesive layer is bonded to the surface of the battery, and the higher the bonding force. When the thickness of the adhesive layer exceeds a specified value, the sites on the surface of the battery have been sufficiently occupied by the adhesive layer, and there is limited room to increase the interfacial bonding force. However, in view of the limited thickness space in the battery compartment, the thicknesses of the first adhesive layer 12 and the second adhesive layer 13 are controlled to fall within the above ranges to achieve a good bonding effect.

As an example, the thickness of the first adhesive layer 12 is 5 μm, 10 μm, 15 μm, 20 μm, 25 μm, 30 μm, 35 μm, 40 μm, or a value falling within a range formed by any two thereof.

As an example, the thickness of the second adhesive layer 13 is 10 μm, 15 μm, 20 μm, 25 μm, 30 μm, 35 μm, 40 μm, 45 μm, 50 μm, or a value falling within a range formed by any two thereof.

Still further, the bonding tape satisfies at least one of the following conditions: (A) the thickness of the first adhesive layer is 5 μm to 15 μm: and (B) the thickness of the second adhesive layer is 10 μm to 25 μm. In this case, a high energy density of the battery is ensured concurrently. In addition, the thickness of the adhesive layer (the overall thickness of the bonding tape 1) also affects its own tensile elastic deformation. The bonding tape fixes the battery 2 in the battery compartment 3. During dropping, the battery 2 is displaced relative to the battery compartment 3, causing the bonding tape to deform. When the amount of deformation is greater than an elastic yield displacement of the bonding tape, the bonding tape is fractured, thereby impairing the effect of fixing the battery. Therefore, an appropriate range of thicknesses needs to be selected.

As an example, the thickness of the first adhesive layer is 5 μm, 8 μm, 10 μm, 11 μm, 13 μm, 15 μm, or a value falling within a range formed by any two thereof.

As an example, the thickness of the second adhesive layer is 10 μm, 15 μm, 20 μm, 25 μm, or a value falling within a range formed by any two thereof.

### Method for Preparing a Bonding Tape:

Step 1: Applying a first adhesive layer for a thickness of 5 to 40 μm continuously on a release film of a specified thickness (8 to 30 μm), where the bonding force of the first adhesive layer is 1100 to 1800 g/in.

The first adhesive layer includes: 10 wt % to 30 wt % natural resin, 0.005 wt % to 0.025 wt % epoxy resin, 60 wt % to 85 wt % viscosity modifier (dispersant, solubilizer, petroleum ether, dichloromethane, and light scattering agent), and 0.1 wt % to 1.5 wt % antioxidant, by mass.

Step 2: Covering the first adhesive layer with a 10 to 50 μm-thick PET substrate layer snugly to obtain a substrate layer containing the first adhesive layer, denoted as an intermediate product a.

Step 3: Applying a second adhesive layer for a thickness of 10 to 50 μm continuously on an adhesive-free side of the substrate layer of the intermediate product a to obtain a substrate layer containing a double-sided adhesive layer, denoted as an intermediate product b, where the bonding force of the second adhesive layer is at least 2500 g/in.

The second adhesive layer includes: 10 wt % to 30 wt % natural resin, 0.005 wt % to 0.025 wt % epoxy resin, 60 wt % to 85 wt % viscosity modifier (dispersant, solubilizer, petroleum ether, dichloromethane, and light scattering agent), and 0.1 wt % to 1.5 wt % antioxidant, by mass.

The second adhesive layer is synthesized with the substrate layer by applying a colloid solution in a single gravure coating operation after one-time sample preparation, so that the adhesive layer and the PET substrate are combined more closely, and the bonding effect is better. When the product is in use, interface delamination between the second adhesive layer and the PET substrate layer is prevented, and the anti-drop performance is good.

Step 4: Affixing an original film PET substrate of a specified thickness (less than 10 μm) and a specified shape to one side of the second adhesive layer, the side being away from the substrate layer, so as to form a first region covered by the original film and a second region not covered by the original film.

The original film PET substrate may be in a shape shown in FIG. 5.

Step 5: Covering the second region with release paper of a specified thickness.

On the one hand, the release paper is configured to protect the second region. Generally, the prepared adhesive tape is rolled in coils. If the coils of the adhesive tape are not interspaced with the release paper, the adhesive tape coils rolled together will be bonded to each other, and will not be able to be detached for use later. On the other hand, the release paper is intended to protect the adhesive tape during storage and transportation and prevent dust and other foreign matters from adhering to the second region and impairing the bonding effect of the adhesive layer in the second region in use later.

Step 6: De-adhering the first adhesive layer with ink, and spraying the ink onto the first adhesive layer according to a specified design to cover a part of the adhesive side. In this way, granular adhesive is obtained on the adhesive layer not covered with ink, and the diameter of the granular adhesive is 0.5 to 2 mm.

Testing the bonding force:
1) Taking an adhesive tape section 30 mm long and 20 mm wide, adhering the adhesive side of the adhesive tape to a stainless steel plate, and letting a small roller of a weight of 1 kg run over the adhesive tape adhered to the stainless steel plate so that the adhesive tape is firmly bonded to the steel plate.
2) Fixing the stainless steel plate vertically to a base surface, and separating the adhesive tape at a lower end of the steel plate from the battery compartment by means of a tensile tester by using a 180° peeling method, during which the tensile tester records the tensile force change, that is, the bonding force of the adhesive tape.

It is hereby noted that the raw material of a colloid in the first adhesive layer and/or the second adhesive layer is not particularly limited in this application. A person skilled in the art may choose the raw material as actually required, as long as the difference in the acting force of the colloid between two sides meets the requirements. The colloid described above is merely an exemplary raw material.

### Mobile Terminal

The mobile terminal contains any one of the bonding tapes disclosed herein above. The mobile terminal may be, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, lithium-ion capacitor, or the like.

The implementations of this application are described below in more detail with reference to embodiments and comparative embodiments.

### Embodiment 1

### Method for Preparing a Bonding Tape

Step 1: Applying a first adhesive layer for a thickness of 15 μm continuously on a 10 μm-thick release film, where the bonding force of the first adhesive layer is 1800 g/in.

Step 2: Covering the first adhesive layer with a 25 μm-thick PET substrate layer snugly to obtain a substrate layer containing the first adhesive layer, denoted as an intermediate product a.

Step 3: Applying a second adhesive layer for a thickness of 25 μm continuously on an adhesive-free side of the substrate layer of the intermediate product a to obtain a substrate layer containing a double-sided adhesive layer, denoted as an intermediate product b, where the bonding force of the second adhesive layer is 2500 g/in.

Step 4: Affixing a 6 μm-thick PET original film to one side of the second adhesive layer, the side being away from the substrate layer, so as to form a second region (shaded part) shown in FIG. 5a.

The distance b₁ from the head end of the substrate layer to the head end of the battery cell in the battery is 1.5 mm, the distance b₂ from the ending end of the substrate layer to the ending end of the battery cell in the battery is 1.5 mm, the distance a₁ from the head end of the second region to the head end of the substrate layer is 4 mm, and the distance a₂ from the ending end of the second region to the ending end of the substrate layer is 4 mm.

The ratio S₂/S₁ of the area S₂ of the second region to the area S₁ of the battery is 0.8. That is, the area of the second region is 80% of the area of a side of the battery, the side facing the bonding tape.

Step 5: Covering the second region with 12 μm-thick release paper.

Step 6: De-adhering the first adhesive layer with ink, so that the area of the granular adhesive is 50% of the total area of the first adhesive layer, and the diameter of the granular adhesive is 1.5 mm, so as to obtain a bonding tape.

Drop test method:
1) Applying the bonding tape prepared in Embodiment 1 to a surface of the battery on a side facing the battery compartment, applying a 5 kgf force for 7 seconds, and then putting the battery into a corresponding type of drop fixture. Applying a 10 kgf force for 7 seconds, putting the cover plate on, leaving the battery to stand for 0.5 hour so that the bonding tape is firmly bonded to the battery and the battery compartment, and then dropping the battery.
2) Manually dropping the battery from a height of 1.5 m several times with the following parts facing the ground successively: front side-back side-lower side-upper side-left side-right side-top left corner-top right corner-bottom left corner-bottom right corner (the side bearing the barcode of the battery cell is the front side). Repeating the above steps to drop the battery for 8 rounds.
3) If the battery swells, leaks the electrolyte solution, emits smoke, or catches fire, stopping the drop test, and measuring and recording the before-drop voltage and the voltage of the battery at 24 hours after the drop respectively. If the voltage at 24 hours after the drop minus the before-drop voltage is less than 30 mV, it is determined that the battery passes the test.
4) Upon completion of the drop test, removing the battery from the fixture. The drop test results are shown in FIG. 1.

### Embodiment 2

Embodiment 2 includes most of the operation steps in Embodiment 1, and differs from Embodiment 1 in that: the shape of the second region in Embodiment 2 is shown in FIG. 5b (shaded part), and the area S₂ of the second region constitutes 60% of the area S₁ of a battery side facing the bonding tape. The bonding tape prepared in Embodiment 2 is affixed to the surface of the battery on a side facing the battery compartment, and the battery is subjected to a drop test. The drop test results are shown in Table 1.

### Embodiment 3

Embodiment 3 includes most of the operation steps in Embodiment 1, and differs from Embodiment 1 in that: the shape of the second region in Embodiment 3 is shown in FIG. 5c (shaded part), and the area S₂ of the second region constitutes 40% of the area of the battery side facing the bonding tape. The bonding tape prepared in Embodiment 3 is affixed to the surface of the battery on a side facing the battery compartment, and the battery is subjected to a drop test. The drop test results are shown in Table 1.

### Comparative Embodiment 1

Applying a wrapping film together with double-sided tape according to the prior art, wrapping the wrapping film around the outer surface of the battery cell, bonding one surface of the wrapping film to the battery cell, and bonding the other surface of the wrapping film to double-sided tape, and then performing a drop test. The drop test results are shown in Table 1.

The thickness of the wrapping film is 68 μm, and the thickness of the double-sided tape is 100 μm. The bonding force of the wrapping film is 1800 g/in, and the bonding force of the double-sided tape is 2500 g/in.

### Comparative Embodiment 2

Affixing the double-sided tape commonly used in the prior art to a battery cell, and then performing a drop test. The drop test results are shown in Table 1.

The thickness of the double-sided tape is 100 μm, and the bonding force of the double-sided tape is 2500 g/in.

### Comparative Embodiment 3

Comparative Embodiment 3 includes most of the operation steps in Embodiment 1, and differs from Embodiment 1 in that the bonding force of the second adhesive layer in Comparative Embodiment 3 is 2000 g/in.

The bonding tape prepared in Comparative Embodiment 3 is affixed to the surface of the battery on a side facing the battery compartment, and the battery is subjected to a drop test. The drop test results are shown in Table 1.

TABLE 1

| | | | | | | Failure | |
|---|---|---|---|---|---|---|---|
| | | | | | | caused by | |
| | Drop | | Top | Crow's | Deformation | 24-hour | Energy |
| | test | | seal | feet on | at head and | voltage | density |
| | pass | Corners | burst | both sides | ending of | drop ≥ 30 | increase |
| | rate | damaged | open | of pocket | battery cell | mV | rate (%) |
| Embodiment 1 | 10/10 | 0/10 | 0/10 | 10/10 | 0/10 | 0/10 | 1.9% |
| | | | | mild | | | |
| Embodiment 2 | 8/10 | 1/10 | 1/10 | 9/10 | 1/10 | 2/10 | 1.9% |
| | | | | mild | mild | | |
| Embodiment 3 | 8/10 | 0/10 | 1/10 | 9/10 | 3/10 | 2/10 | 1.9% |
| | | | | mild | mild | | |
| Comparative | 6/10 | 4/10 | 0/10 | 8/10 | 6/10 | 4/10 | 0 |
| Embodiment 1 | | | | mild to | moderate | | |
| | | | | moderate | | | |
| Comparative | 5/10 | 4/10 | 1/10 | 10/10 | 7/10 | 5/10 | 1.3% |
| Embodiment 2 | | | | moderate | moderate | | |
| | | | | to severe | | | |
| Comparative | 5/10 | 4/10 | 0/10 | 8/10 | 8/10 | 3/10 | 1.9% |
| Embodiment 3 | | | | mild | moderate | | |

Note:
A battery compliant with the following criteria is deemed to pass the test: no swelling, no electrolyte leakage, no smoke emission, no fire, and 24-hour voltage drop less than 30 mV.
The crow's feet indicate the following meanings: Moderate or mild crow's feet indicate a relatively good effect of bonding between the battery cell and the fixture; however, severe crow's feet and pocket fatigue may cause breakage along the wrinkles of the crow's feet.

As can be seen from the above results, in Embodiment 1, the drop test results are the best, the test pass rate is the highest, the failure rate caused by the 24-hour voltage drop greater than or equal to 30 mV is the lowest, and the appearance of the battery shows no obvious deformation. The test results of Embodiment 2 are similar to the test results of Embodiment 3, but slightly inferior to Embodiment 1. That is because the area of the second region in Embodiment 1 (accounting for approximately 80% of the area of the battery) is larger than the area of the second region in Embodiment 2 and Embodiment 3 (accounting for approximately 60% and 40% of the area of the battery; respectively). When the bonding force of the first adhesive layer is the same, the larger the area of the second region, the stronger the adhesion between the battery and the adhesive tape and the battery compartment.

The drop test results of Embodiments 1 to 3 are superior to Comparative Embodiment 1. In Embodiments 1 to 3, the first region and second region formed are covered with an original film. In Comparative Embodiment 1, the battery compartment, the double-sided tape, the wrapping film, and the battery may be regarded as three separate wholes, so that the battery is not well fixed in a case of dropping and is damaged severely in the battery compartment. In contrast to Comparative Embodiment 1. Embodiments 1 to 3 are free from the phenomenon of sliding or loose bonding between the second region and the PET substrate layer. In ideal status, the second adhesive layer in Embodiments 1 to 3 can well bond the battery compartment (fixture) and the battery by using the original film to cover the exposed second region, and fix the battery properly in the battery compartment (fixture), so that the wobbling of the battery is slight. However, in Comparative Embodiment 1, there is a gap between the double sided tape and the wrapping film. Consequently, the battery is not well fixed in the battery compartment and collides severely in the battery compartment, and the corners are damaged obviously, as shown in FIG. 8a′ and FIG. 8b′: and the head and ending are deformed severely, as shown in FIG. 9. The deformation of the head and ending may lead to abrasion of the film.

During the drop, the shearing force of the strong adhesive tape is large. In Embodiments 1 to 3, the shearing force is dispersed by the PET substrate, and does not act directly on the surface of the battery, thereby avoiding the formation of severe crow's feet that lead to film abrasion. The bonding force of the double-sided tape in Comparative Embodiment 2 is stronger than the bonding force of the wrapping film. During drop of the battery, moderate and severe crow's feet are formed. Consequently, the pouch fails because the corners of the pouch are broken along the crow's feet, as shown in FIG. 8a′. In Embodiments 1 to 3, the second adhesive layer is of high adhesiveness, and the bonding tape may be regarded as being combined with the battery compartment and the pouch to form a whole, so that the battery can be well fixed in the battery compartment. In Comparative Embodiment 3, the difference between the second bonding force F₂ and the first bonding force F₁ is unduly small. Consequently, the battery is not well fixed during a drop, and is damaged severely in the battery compartment.

It can be seen that the new type of composite adhesive tape (that is, the bonding tape of this application) reduces the overall thickness of adhesive tape, improves the energy density of the battery, and at the same time, improves the anti-drop performance of the battery, and increases the drop window pass rate.

In the accompanying drawings of this application, the same or similar reference numerals represent the same or similar components. In the description of this application, understandably, a direction or positional relationship indicated by the terms such as “up”, “down”, “left”, and “right” is a direction or positional relationship based on the illustration in the drawings, and is merely intended for ease or simplicity of describing this application, but not intended to indicate or imply that the indicated device or component is necessarily located in the specified position or constructed or operated in the specified direction or position. Therefore, the terms depicting the positional relationship in the drawings are merely for illustrative purposes, but not to be understood as any limitation on this patent. A person of ordinary skill in the art may understand the specific meanings of such terms depending on specific situations.

What is described above is merely exemplary embodiments of this application, but is not intended to limit this application. Any modifications, equivalent substitutions, and improvements made without departing from the spirit and principles of this application still fall within the protection scope of this application.

What is claimed is:

1. A bonding tape for fixing a battery, comprising a first adhesive layer, a substrate layer, a second adhesive layer, and an original film along a first direction: the first adhesive layer and the second adhesive layer are located on two sides of the substrate layer respectively, and the first direction is a thickness direction of the bonding tape; and the first adhesive layer is configured to be bonded to the battery, the second adhesive layer comprises a first region and a second region, the original film is disposed in the first region on a surface facing away from the substrate layer, and the second region is configured to be bonded to a battery compartment.

2. The bonding tape according to claim 1, wherein, along the first direction, a projected area of the original film is A, and a projected area of the second adhesive layer is B, wherein 0.1≤A/B≤0.7.

3. The bonding tape according to claim 2, wherein, 0.2≤A/B≤0.5.

4. The bonding tape according to claim 1, wherein, a shape of the second region comprises one or more of a rectangle, a square, a triangle, a circle, or another regular or irregular shape.

5. The bonding tape according to claim 1, wherein the original film contains a through-hole.

6. The bonding tape according to claim 1, wherein the first adhesive layer contains a granular adhesive; and an area of the granular adhesive constitutes 30% to 70% of an area of a side of the first adhesive layer, and the side is facing away from the substrate laver.

7. The bonding tape according to claim 1, wherein a ratio of a thickness of the second adhesive layer to a thickness of the first adhesive layer is M, and 1.5≤M≤2.

8. The bonding tape according to claim 1, wherein, the bonding tape satisfies at least one of the following conditions:
(A) a thickness of the first adhesive layer is 5 μm to 40 μm: or
(B) a thickness of the second adhesive layer is 10 μm to 50 μm.

9. The bonding tape according to claim 8, wherein, the bonding tape satisfies at least one of the following conditions:
(A) the thickness of the first adhesive layer is 5 μm to 15 μm; and
(B) the thickness of the second adhesive layer is 10 μm to 25 μm.

10. The bonding tape according to claim 1, wherein, along a second direction, the second region is disposed on both sides of the first region, wherein the second direction is a width direction of the bonding tape.

11. A mobile terminal, wherein, the mobile terminal comprises the battery compartment: the battery; and the bonding tape according to claim 1; and the battery is fixed in the battery compartment by the bonding tape.

12. The mobile terminal according to claim 11, wherein a bonding force between the first adhesive layer and the battery is a first bonding force F₁, and a bonding force between the second adhesive layer and the battery compartment is a second bonding force F₂, and F₁<F₂.

13. The mobile terminal according to claim 12, wherein F₂−F₁≥700 g/in.

14. The mobile terminal according to claim 11, wherein a lifting portion is disposed between the first adhesive layer and the battery:
the lifting portion comprises a first part and a second part, the first part contains a bonding layer, and the bonding layer is configured to be bonded to the battery; and
the second part extends to a side of the battery, and the side is facing away from the first adhesive layer.

15. The mobile terminal according to claim 11, wherein, along the first direction, a projected area of a side of the battery, the side being bonded to the first adhesive layer, is denoted by S₁, and a projected area of the second region is denoted by S₂, and 0.3≤S₂/S₁≤0.9.

16. The mobile terminal according to claim 15, wherein 0.5≤S₂/S₁≤0.8.

17. The mobile terminal according to claim 11, wherein, a third direction is a protruding direction of a tab of the battery, and, along the third direction, the mobile terminal satisfies at least one of the following conditions:
1) a distance from a head end of the second region to a head end of the substrate layer is 0.5 mm to 5 mm;
2) a distance from an ending end of the second region to an ending end of the substrate layer is 0.5 mm to 5 mm;
3) a distance from the head end of the substrate layer to a head end of a battery cell in the battery is 0.2 mm to 5 mm; or
4) a distance from the ending end of the substrate layer to an ending end of the battery cell in the battery is 0.2 mm to 5 mm.

18. The mobile terminal according to claim 17, wherein, the mobile terminal satisfies at least one of the following conditions:
1) the distance from the head end of the second region to the head end of the substrate layer is 3 mm to 5 mm;
2) the distance from the ending end of the second region to the ending end of the substrate layer is 3 mm to 5 mm;
3) the distance from the head end of the substrate layer to the head end of the battery cell in the battery is 0.5 mm to 3 mm; or
4) the distance from the ending end of the substrate layer to the ending end of the battery cell in the battery is 0.5 mm to 3 mm.

19. The mobile terminal according to claim 11, wherein the original film contains a through-hole.

20. The mobile terminal according to claim 11, wherein, along a second direction, the second region is disposed on both sides of the first region, wherein the second direction is a width direction of the bonding tape.
